(19) United States
(12) Patent Application Publication
(10) Pub. No.: US 2024/0022344 A1
(43) Pub. Date: Jan. 18, 2024

(54) PILOT FREQUENCY SEQUENCE GENERATION METHOD AND APPARATUS

(71) Applicant: SPREADTRUM COMMUNICATIONS (SHANGHAI) CO., LTD., Shanghai (CN)

(72) Inventors: Qing LIU, Shanghai (CN); Mingwei CAO, Shanghai (CN)

(73) Assignee: SPREADTRUM COMMUNICATIONS (SHANGHAI) CO., LTD., Shanghai (CN)

(21) Appl. No.: 18/251,441

(22) PCT Filed: Nov. 4, 2021
(86) PCT No.: PCT/CN2021/128551

§ 371 Date: May 2, 2023

(30) Foreign Application Priority Data
Nov. 4, 2020 (CN) 202011217195.7

(51) Int. Cl. H04J 13/12; H04J 13/00; H04L 5/00

(52) U.S. Cl. CPC H04J 13/12; H04J 13/004; H04L 5/0048

(57) ABSTRACT

Disclosed in the present invention are a method and an apparatus for generating a pilot frequency sequence. The method comprises: generating a data pilot frequency by a data pilot frequency generator of a transmitting end, and generating a multi-stream data pilot frequency sequence by a multi-stream data pilot frequency sequence mapper of the transmitting end; generating an orthogonal code by an orthogonal code generator of the transmitting end, and generating an extracted orthogonal code word by a column loop extractor of the transmitting end; obtaining, by the transmitting end, a data pilot frequency sending value by multiplying the multi-stream data pilot frequency sequence of each symbol by the corresponding orthogonal code word; and sending the data pilot frequency sending value to a receiving end. The present invention effectively improves the accuracy of phase tracking obtained at the receiving end, and thus, high-order modulation can be effectively dealt with.

### CROSS-REFERENCE TO RELATED APPLICATIONS

The present application is a National Stage of International Application No. PCT/CN2021/128551, filed on Nov. 4, 2021, which claims priority to Chinese Patent Application No. 202011217195.7 filed on Nov. 4, 2020, the contents of all of which are incorporated herein by reference in their entireties.

### TECHNICAL FIELD

The present disclosure relates to the technical field of wireless communications, and in particular to a method and apparatus for generating a multi-stream pilot frequency sequence applied to a Wi-Fi (wireless fidelity) communication system.

### BACKGROUND

For Wi-Fi, a low-speed mobile communication system, signals are usually transmitted independently in frames, the duration of one frame of signal is designed to be less than the channel coherence time, thus channel estimation may be simply estimated by sending a TS (training sequence) sequence at a frame head, and the channel for subsequent time is considered to remain unchanged.

Due to limited spectral bandwidth, wireless communication requires a communication technology with high spectral efficiency. A MIMO (multiple input multiple output) technology emerges as the times require, which can improve spectral efficiency by using a multi-antenna technology for spatial multiplexing; in addition, high order modulation is also a means to improve the spectral efficiency, for example, Wi-Fi6 has used 1024QAM (quadrature amplitude modulation) modulation.

Both high spectral MIMO technology and 1024QAM technology present a challenge for carrier frequency offset estimation and channel estimation. When the carrier frequency offset estimation has errors, it is superimposed on a channel to form phase rotation, and a rotation value increases linearly with the increase of the number of OFDM (orthogonal frequency division multiplexing) symbols. However, the TS sequence only exists at a frame head, and only the channel estimation of the frame head can be estimated, but the phase rotation superimposed on the channel cannot be known for the subsequent data OFDM symbol. The higher the modulation order, the greater the effect of the phase rotation on demodulation.

Therefore, in a Wi-Fi protocol, a pilot frequency is added to the data OFDM symbol to help estimate the phase rotation. Due to the use of 1024QAM, the more accurate the phase rotation estimation, the higher the demodulation SNR (signal-to-noise ratio). For a MIMO frame sent simultaneously with multi-stream, the TS sequence is sent per stream, for example, 4 streams are sent simultaneously, and then 4 TSs are sent to estimate a channel of the stream. Since signals are superimposed, a receiving end needs to use an orthogonal code to obtain the channel estimation of 4 streams. When the receiving end receives 4 TSs, the orthogonal code is removed to obtain the channel estimation of 4 streams.

When the orthogonal code is removed, it is necessary to assume that channels of 4 TS s are completely consistent, which is determined due to low mobility, but carriers will not be completely co-frequency, so that there is a frequency error, resulting in different phase rotations among 4 TSs. In this case, a solution is to insert the pilot frequency into the TS, and 4 TSs have the same pilot frequency, so that during the reception, the pilot frequency can be used to compensate for the phase rotation of each TS, and then the orthogonal code is removed to obtain the channel estimation of 4 streams. Similarly, the same pilot frequency is inserted for the data OFDM symbol to solve the phase rotation of the data part.

However, since the pilot frequency cannot distinguish the channel estimation (superimposing phase rotation) of each pilot frequency point stream, it can only use a linear combination of each stream as a received quantity, and conjugate and multiply it with the received quantity of the linear combination of previous streams to obtain an ideal product of sum square quantity (such as |a+b+c|\hat{ }2) and phase rotation, which can estimate the phase rotation. However, such estimation is not most ideal, and it is most ideal to obtain an ideal product of sum of squares quantity (such as (|a|\hat{ }2+|b|\hat{ }+|c|\hat{ }2)) and the phase rotation, so that the phase rotation can be estimated more accurately.

### SUMMARY

A technical problem to be solved by the present disclosure is to overcome a defect that a method for generating a pilot frequency in the prior art cannot obtain accurate phase tracking, which leads to an inability to be well applied to high-order modulation, so it provides a method and apparatus for generating a pilot frequency sequence.

The present disclosure solves the above technical problem through the following technical solutions:

Provided is a method for generating a pilot frequency sequence, which comprises:
generating a data pilot frequency by a data pilot frequency generator of a transmitting end, and generating a multi-stream data pilot frequency sequence by a multi-stream data pilot frequency sequence mapper of the transmitting end;
generating an orthogonal code by an orthogonal code generator of the transmitting end, and generating an extracted orthogonal code word by a column loop extractor of the transmitting end;
obtaining, by the transmitting end, a data pilot frequency sending value by multiplying the multi-stream data pilot frequency sequence of each symbol by the corresponding orthogonal code word; and sending, by the transmitting end, the data pilot frequency sending value to a receiving end.

Optionally, the method further comprises:
obtaining a TS pilot frequency sending value by generating a pilot frequency TS pilot frequency by a TS pilot frequency generator of the transmitting end and generating a multi-stream TS pilot frequency sequence by a multi-stream TS pilot frequency sequence mapper of the transmitting end; and sending the TS pilot frequency sending value to the receiving end.

Optionally, the method further comprises:
generating a multi-stream TS OFDM symbol and a multi-stream data OFDM symbol by an OFDM symbol generator of the transmitting end, inserting the multi-stream TS pilot frequency sequence between the multi-stream TS OFDM symbols, and inserting the multi-stream data pilot frequency sequence between the multi-stream data OFDM symbols.

Optionally, the method further comprises:
obtaining, by the receiving end, TS phase estimation in response to receiving the TS pilot frequency sending value and the data pilot frequency sending value from the transmitting end; compensating, by the receiving end, the TS phase estimation;
obtaining, by the receiving end, channel estimation of a TS pilot frequency point by removing an orthogonal matrix on a TS non pilot frequency position and performing channel estimation, and performing interpolation,;
and performing, by the receiving end, phase offset compensation by estimating phase offset according to the channel estimation and current pilot frequency and updating the phase offset.

Optionally, obtaining the TS phase estimation and compensating the TS phase estimation comprises:

estimating TS phase rotation by conjugating and multiplying TS adjacent symbols to obtain a product of sum square and phase rotation; and compensating the TS phase rotation.

Optionally, the method for generating the pilot frequency sequence is applied to a Wi-Fi communication system.

Provided is an apparatus for generating a pilot frequency sequence, which comprises a transmitting end and a receiving end;
wherein the transmitting end is configured to generate a data pilot frequency by a data pilot frequency generator, and generate a multi-stream data pilot frequency sequence by a multi-stream data pilot frequency sequence mapper;
the transmitting end is further configured to generate an orthogonal code by an orthogonal code generator, and generate an extracted orthogonal code word by a column loop extractor;
and the transmitting end is further configured to obtain a data pilot frequency sending value by multiplying the multi-stream data pilot frequency sequence of each symbol by the corresponding orthogonal code word, and send the data pilot frequency sending value to a receiving end.

Optionally, the transmitting end is further configured to obtain a TS pilot frequency sending value and send the TS pilot frequency sending value to the receiving end by generating a pilot frequency TS pilot frequency by a TS pilot frequency generator and generating a multi-stream TS pilot frequency sequence by a multi-stream TS pilot frequency sequence mapper.

Optionally, the transmitting end is further configured to generate a multi-stream TS OFDM symbol and a multi-stream data OFDM symbol by an OFDM symbol generator, insert the multi-stream TS pilot frequency sequence between the multi-stream TS OFDM symbols, and insert the multi-stream data pilot frequency sequence between the multi-stream data OFDM symbols.

Optionally, the receiving end is configured to, in response to receiving the TS pilot frequency sending value and the data pilot frequency sending value from the transmitting end, obtain TS phase estimation and compensate the TS phase estimation;
the receiving end is further configured to, by removing an orthogonal matrix on a TS non pilot frequency position and performing channel estimation, and performing interpolation, obtain the channel estimation of a TS pilot frequency point;
and the receiving end is further configured to perform phase offset compensation by estimating phase offset according to the channel estimation and current pilot frequency, and updating the phase offset.

Optionally, the receiving end is configured to estimate TS phase rotation by conjugating and multiplying TS adjacent symbols to obtain a product of sum square and phase rotation, and compensate the TS phase rotation.

Optionally, the apparatus for generating the pilot frequency sequence is applied
to a Wi-Fi communication system.

Provided is an electronic device, which comprises a memory, a processor and a computer program stored on the memory and executable on the processor, the processor, when executing the computer program, implementing steps of the above method for generating the pilot frequency sequence.

Provided is a computer-readable medium, which has a computer instruction stored thereon, the computer instruction, when executed by a processor, implementing steps of the above method for generating the pilot frequency sequence.

On the basis of the general knowledge in the art, the preferred conditions can be combined arbitrarily to obtain preferred embodiments of the present disclosure.

The positive and progressive effects of the present disclosure are as follows:

According to the method and apparatus for generating the pilot frequency sequence provided by the present disclosure, a pilot frequency of a data part is multiplied by an orthogonal code, so that pilot frequencies between streams are kept orthogonal, and the accuracy of phase tracking obtained at the receiving end is effectively improved, and thus, high-order modulation such as 1024QAM can be effectively dealt with.

### BRIEF DESCRIPTION OF THE DRAWINGS

The features and advantages of the present disclosure may be better understood upon reading the detailed description of embodiments thereof in conjunction with the following drawings. In the drawings, components are not necessarily drawn to scale, and components having similar associated characteristics or features may have the same or similar reference numerals.

FIG. 1 is a schematic flow chart of a method for generating a pilot frequency sequence according to an embodiment of the present disclosure.

FIG. 2 is a schematic diagram of a TSᵢ formation process in a time domain.

FIG. 3 is a diagram of a sending value of a certain pilot frequency point of different symbols.

FIG. 4 is a schematic structural diagram of a transmitting end of an apparatus for generating a pilot frequency sequence according to another embodiment of the present disclosure.

FIG. 5 is a schematic structural diagram of an electronic device implementing a method for generating a pilot frequency sequence according to another embodiment of the present disclosure.

### DETAILED DESCRIPTION

The present disclosure is further illustrated by the following embodiments, which are not intended to limit the present disclosure.

In order to overcome the above existing defect, the present embodiments provide a method for generating a pilot frequency sequence, comprising: generating a data pilot frequency by a data pilot frequency generator of a transmitting end, and generating a multi-stream data pilot frequency sequence by a multi-stream data pilot frequency sequence mapper of the transmitting end; generating an orthogonal code by an orthogonal code generator of the transmitting end, and generating an extracted orthogonal code word by a column loop extractor of the transmitting end; and obtaining, by the transmitting end, a data pilot frequency sending value by multiplying the multi-stream data pilot frequency sequence of each symbol by the corresponding orthogonal code word; and sending, by the transmitting end, the data pilot frequency sending value to a receiving end.

The method for generating the pilot frequency sequence provided by the embodiments is applied to a Wi-Fi communication system, mainly in MIMO spatial multiplexing and high QAM modulation, which may effectively improve the accuracy and efficiency of phase tracking.

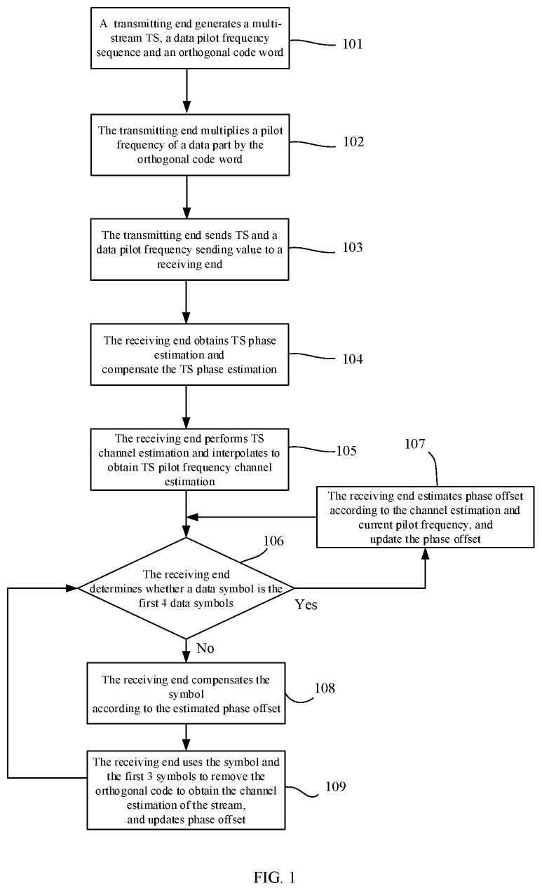

Specifically, as one embodiment, as shown in FIG. 1, a method for generating a pilot frequency sequence provided by the embodiment mainly includes the following steps:

In step 101, a transmitting end generates a multi-stream TS, a data pilot frequency sequence and an orthogonal code word.

In the step, taking 4 streams as an example, the transmitting end generates a pilot frequency TS pilot frequency P by a TS pilot frequency generator, and generates a multi-stream same TS pilot frequency sequence by a multi-stream TS pilot frequency sequence mapper, where the multi-stream TS pilot frequency sequence is [P P P P].

In the step, the transmitting end further generates a pilot frequency P by a data pilot frequency generator, and a multi-stream data pilot frequency sequence mapper generates a multi-stream same data pilot frequency sequence, where the multi-stream data pilot frequency sequence is [P P P P].

In the step, the transmitting end further generates an orthogonal code C by an orthogonal code generator, where a C sequence is expressed as

$$C = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ]$$

Each value in the C sequence is C_{j,i}, j represents a j-th stream, 1≤j≤4, i is a i-th symbol 1≤i≤4. Through a column loop extractor, each symbol extracts one column of C, and assuming a n-th symbol, the extracted orthogonal code word is C_{1:4,n mod(4)}.

In step 102, the transmitting end multiplies a pilot frequency of a data part by the orthogonal code word.

In the step, a multi-stream data pilot frequency sequence of each symbol is multiplied by the corresponding orthogonal code word C_{1:4,n mod (4)} to obtain a final data pilot frequency sending value, and taking a first symbol as an example, the generated multi-stream pilot frequency is multiplied by corresponding bits of

$$[ \begin{matrix}1 \\ 1 \\ 1 \\ - 1\end{matrix} ]$$

and

$$[ \begin{matrix}P \\ P \\ P \\ P\end{matrix} ]$$

to obtain

$$[ \begin{matrix}P \\ P \\ P \\ - P\end{matrix} ] ,$$

, which is used for four streams, respectively.

Where the transmitting end generates a multi-stream TS OFDM symbol and a multi-stream data OFDM symbol by an OFDM symbol generator, insert the multi-stream TS pilot frequency sequence between the multi-stream TS OFDM symbols, and insert the multi-stream data pilot frequency sequence between the multi-stream data OFDM symbols.

In step 103, the transmitting end sends TS and the data pilot frequency sending value to the receiving end.

In the step, the transmitting end transmits the TS pilot frequency sending value obtained based on the multi-stream TS pilot frequency sequence and the data pilot frequency sending value as described above to the receiving end.

Specifically, in order to facilitate the receiving end to estimate phase rotation of a data symbol, when a signal is transmitted, the pilot frequency is inserted between the multi-stream TSs and the data OFDM symbols, and all pilot frequency values are the same (same for each stream). Since whether it is the TS or the data symbol, in a frequency domain, the pilot frequency is affected by the phase rotation in addition to channel fading. Therefore, if the pilot frequency value (usually 1 or −1) is not considered, the received frequency domain signal is a linear combination of each stream channel Since all pilot frequencies are in the same mode, whether it is the TS or the data symbol, where the frequency domain receiving signal at the pilot frequency point is the same linear combination, the phase rotation can be easily obtained by conjugating and multiplying.

For example, taking a pilot frequency point as an example, a pilot frequency value may be +1 or −1 in the TS and the data symbol. Taking 4-sending and 4-receiving for sending 4 streams pilot frequency as an example, a receiving frequency domain signal of a pilot frequency point in the l+1-th OFDM symbol is

$${R}_{1} ( l + 1 ) = {H}_{1} * [ \begin{matrix}p \\ p \\ p \\ p\end{matrix} ] * exp ( 1 j * l θ ) + N ,$$

$$H = [ \begin{matrix}{H}_{1} \\ {H}_{2} \\ {H}_{3} \\ {H}_{4}\end{matrix} ] , {H}_{j} = [ {H}_{j 1} {H}_{j 2} {H}_{j 3} {H}_{j 4} ] ,$$

$$R = [ \begin{matrix}{R}_{1} \\ {R}_{2} \\ {R}_{3} \\ {R}_{4}\end{matrix} ] , N = [ \begin{matrix}{N}_{1} \\ {N}_{2} \\ {N}_{3} \\ {N}_{4}\end{matrix} ]$$

Rᵢ is a signal received by an antenna i, N is a noise matrix, H is a channel matrix, and Hⱼᵢ is a channel from a sending antenna i to a receiving antenna j. θ is phase rotation of a second TS relative to a first TS.

Taking the receiving antenna 1 as an example,

$$\begin{matrix}{R}_{1} ( l + 1 ) = {H}_{1} * [ \begin{matrix}p \\ p \\ p \\ p\end{matrix} ] * exp ( 1 j * l θ ) + {N}_{1} \\ = ( {H}_{11} + {H}_{12} + {H}_{13} + {H}_{14} ) * \\ exp ( 1 j * l θ ) * p + {N}_{1}\end{matrix}$$

thus, by multiplying it with the first TS, it can obtain that

R₁(l+1)*R₁(1)*=p²*|H₁₁+H₁₂+H₁₃+H₁₄|²*exp(1j*lθ)+Ñ₁

Ñ₁ is an equivalent noise. Typically, a value of p² is 1, and it can be seen

$$\begin{matrix}θ = angle ( {R}_{1} ( l + 1 ) * {{R}_{1} ( 1 )}^{*} ) / l \\ = angle ( [ exp ( 1 j * l θ ) + \frac{{N}_{1}}{{\vert {H}_{11} + {H}_{12} + {H}_{13} + {H}_{14} \vert}^{2}} ] ) / l\end{matrix}$$

from the above formula that

$$\frac{{\tilde{N}}_{1}}{{\vert {H}_{11} + {H}_{12} + {H}_{13} + {H}_{14} \vert}^{2}}$$

determines the estimation accuracy, that is, |H₁₁+H₁₂+H₁₃+H₁₄|² determines the accuracy.

The value of |H₁₁+H₁₂+H₁₃+H₁₄|² can cancel out each other, and thus, even in small channel fading, it is possible to obtain small |H₁₁+H₁₂+H₁₃+H₁₄|², resulting in inaccurate estimation and affecting demodulation.

However, in the embodiment, the improved pilot frequency sequence may be used to obtain a channel of a pilot frequency point stream, that is, at a certain pilot frequency point, a receiving signal of an antenna 1 may be obtained as

Rx₁(l+1)=[H₁₁,H₁₂,H₁₃,H₁₄]*exp(1j*lθ)*p+N₁

It can derive

$$\begin{matrix}θ = angle ( {Rx}_{1} ( l + 1 ) * {{Rx}_{1} ( 1 )}^{*} ) / l \\ = angle ( [ exp ( 1 j * l θ ) + \frac{{{N}^{⌢}}_{1}}{{\vert {H}_{11} \vert}^{2} + {\vert {H}_{12} \vert}^{2} + {\vert {H}_{13} \vert}^{2} + {\vert {H}_{14} \vert}^{2}} ] ) / l\end{matrix}$$

In this way,

$$\frac{{{N}^{⌢}}_{1}}{( {\vert {H}_{11} \vert}^{2} + {\vert {H}_{12} \vert}^{2} + {\vert {H}_{13} \vert}^{2} + {\vert {H}_{14} \vert}^{2} )}$$

determines the estimation accuracy, that is, (|H₁₁|²+|H₁₂|²+|H₁₃|²+|H₁₄|²) determines the accuracy, so that as long as the channel fading of a stream is small, the value of (|H₁₁|²+|H₁₂|²+|H₁₃|²+|H₁₄|²) is large, and the phase estimation accuracy can be ensured.

Taking 20 M bandwidth, 4 streams as an example, a TS sequence mainly consists of 4 TSs, and a time domain of TS is as follows, where TS, represents TS of a i-th symbol.

| | | | | | | | |
|---|---|---|---|---|---|---|---|
| CP | TS₀ | CP | TS₁ | CP | TS₂ | CP | TS₃ |

FIG. 2 shows a TS, formation process in a time domain.

A frequency domain training sequence is TS_F, a length is 53, a carrier range is [−26:26], and a pilot frequency position is located in [−21, −7, 7, 21]. Data of a non pilot frequency position is expressed as TS_F_D, and data of a pilot position is expressed as TS_F_P. An orthogonal matrix is C.

$$C = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ]$$

In the i-th symbol, the TS_F_D point of different streams is multiplied by a i-th column of C, and the TS_F_P of different streams is multiplied by C₀ᵢ. According to an original protocol, the data part pilot frequency is also processed in the same way.

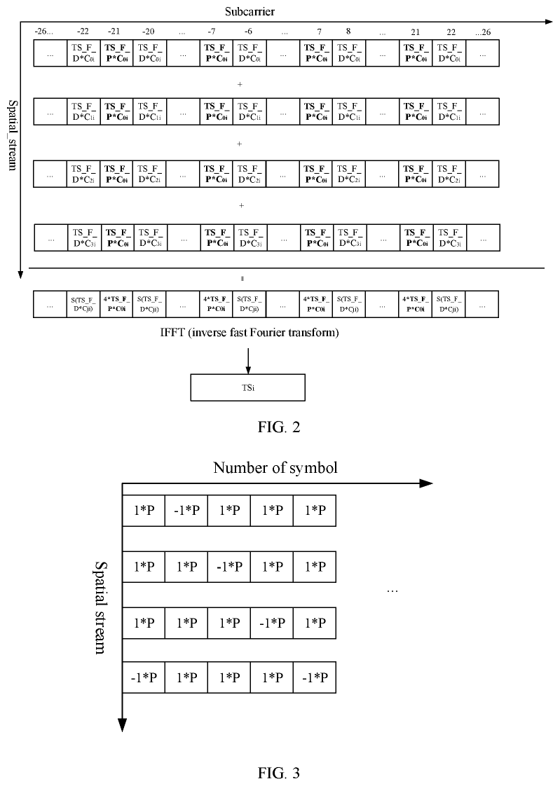

In the embodiment, the TS part pilot frequency pattern is unchanged, and thus, the TS part phase tracking performance is also unchanged. The phase estimation precision of the data part may be improved as described in detail below. The pilot frequency of the data part is multiplied by the orthogonal code to keep pilot frequencies between streams orthogonal, and taking 4 streams as an example, the sending value of a certain pilot frequency point of different symbols is as shown in FIG. 3, where P is a pilot frequency value.

From a time perspective, a 5-th symbol begins to repeat a cycle of the first four symbols. The TS part pilot frequency is a pilot frequency that does not distinguish the stream, which is the same as the existing protocol. The receiving end may obtain the phase estimation with reference to sum of squares in the following manner. Taking 4 streams as an example, the implementation process is as follows.

In step 104, the receiving end obtains TS phase estimation and compensates the TS phase estimation.

In the step, the receiving end, in response to receiving the TS pilot frequency sending value and the data pilot frequency sending value from the transmitting end, obtains the TS phase estimation and compensates the TS phase estimation.

Where the pilot frequency between each TS stream is the same, and adjacent symbols are conjugated and multiplied to obtain a product of sum square (such as |a+b+c|\hat{ }2) and phase rotation. This can estimate the phase rotation and then compensate the phase rotation.

In step 105, the receiving end performs TS channel estimation and interpolates to obtain TS pilot frequency channel estimation.

In the step, the receiving end, by removing an orthogonal matrix on a TS non pilot frequency position and performing channel estimation, and performing interpolation, obtains the channel estimation of a TS pilot frequency point.

Since the pilot frequency is not distinguished according to the steam, the channel estimation of the pilot frequency position can not be directly obtained, but by removing the orthogonal matrix on the TS non pilot frequency position and performing the channel estimation, and then performing the interpolation, it can obtain channel estimation Hᵢₙₜₑᵣₚ of the pilot frequency point

H_{int erp}=[H_{int erp}(1)H_{int erp}(2)H_{int erp}(3)H_{int erp}(4) . . . ].

1, 2, 3, 4 represent the number of streams.

In step 106, the receiving end determines whether a data symbol is the first 4 data symbols, if yes, step 107 is performed, and if not, step 108 is performed.

In step 107, the receiving end estimates phase offset by using the channel estimation and current pilot frequency and updates the phase offset. After step 107 is performed, return to step 106.

In step 108, the receiving end compensates for the symbol according to the estimated phase offset.

In step 109, the receiving end uses the symbol and the first 3 symbols to remove the orthogonal code to obtain the channel estimation of streams, and updates phase offset θ. After step 109 is performed, return to step 106.

Specifically, in the embodiment, taking 4 streams as an example, 4 symbols are required to obtain the channel estimation at the same pilot frequency position of 4 streams, and starting from the 5-th symbol, the estimated phase offset is used for compensation, and then the symbol and the first 3 symbols are used to remove the orthogonal code to obtain the channel estimation [Hᵢ(1) Hᵢ(2) Hᵢ(3) Hᵢ(4)] of the stream, where i represents a symbol index, for example, if the current symbol is the 5-th symbol, i=5. Corresponding bits of [Hᵢ(1) Hᵢ(2) Hᵢ(3) Hᵢ(4)] and Hᵢₙₜₑᵣₚ are conjugated and multiplied and summed, since the channel remains unchanged from TS, a product value of sum square and phase rotation is obtained, a residual phase offset is estimated, and the phase offset θ is updated for phase offset compensation of the next symbol, and so on for the following symbols. Specifically, the first 4 symbols are linearly combined with the current symbol pilot frequency in the same mode by using the channel estimation Hᵢₙₜₑᵣₚ and then conjugated and multiplied by the current symbol pilot frequency to estimate the phase offset θ.

According to the method for generating the pilot frequency sequence provided by the present embodiments, a pilot frequency of a data part is multiplied by an orthogonal code, so that pilot frequencies between streams are kept orthogonal, and the accuracy of phase tracking obtained at the receiving end is effectively improved, and thus, high-order modulation can be effectively dealt with.

In order to overcome the above existing defect, the embodiments further provide an apparatus for generating a pilot frequency sequence, where the apparatus for generating the pilot frequency sequence uses the method for generating the pilot frequency sequence as described above, and the apparatus for generating the pilot frequency sequence is applied to a Wi-Fi communication system.

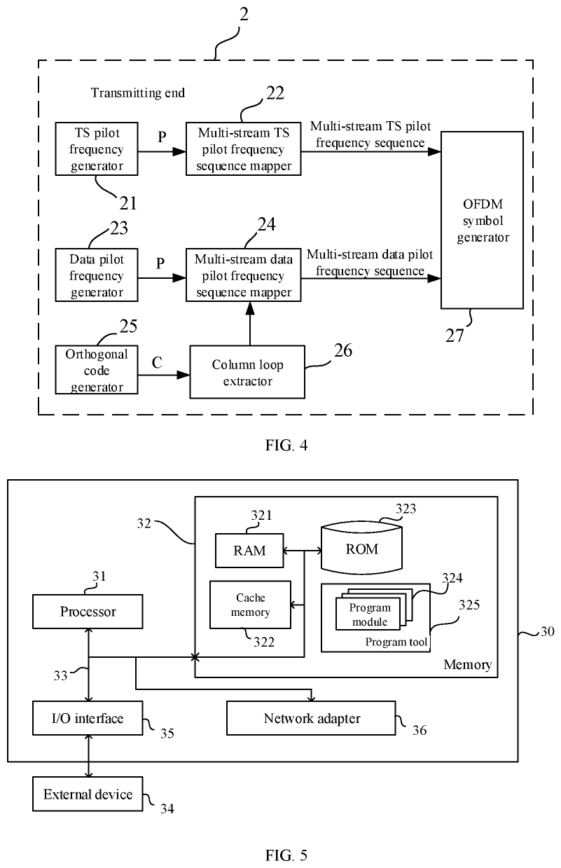

Specifically, as shown in FIG. 4, the apparatus for generating the pilot frequency sequence mainly includes a transmitting end 2 and a receiving end, where the transmitting end 2 mainly includes a TS pilot frequency generator 21, a multi-stream TS pilot frequency sequence mapper 22, a data pilot frequency generator 23, a multi-stream data pilot frequency sequence mapper 24, an orthogonal code generator 25, a column loop extractor 26, and an OFDM symbol generator 27.

The transmitting end 2 is configured to obtain a TS pilot frequency sending value and send the TS pilot frequency sending value to the receiving end by generating a pilot frequency TS pilot frequency by the TS pilot frequency generator 21 and generating a multi-stream TS pilot frequency sequence by the multi-stream TS pilot frequency sequence mapper 22.

The transmitting end 2 is further configured to generate a data pilot frequency by the data pilot frequency generator 23, and generate a multi-stream data pilot frequency sequence by the multi-stream data pilot frequency sequence mapper 24.

The transmitting end 2 is further configured to generate an orthogonal code by the orthogonal code generator 25, and generate an extracted orthogonal code word by the column loop extractor 26.

The transmitting end 2 is further configured to obtain a data pilot frequency sending value by multiplying the multi-stream data pilot frequency sequence of each symbol by the corresponding orthogonal code word, and send the data pilot frequency sending value to a receiving end.

The transmitting end 2 is further configured to generate a multi-stream TS OFDM symbol and a multi-stream data OFDM symbol by the OFDM symbol generator 27, insert the multi-stream TS pilot frequency sequence between the multi-stream TS OFDM symbols, and insert the multi-stream data pilot frequency sequence between the multi-stream data OFDM symbols.

The receiving end is configured to, in response to receiving the TS pilot frequency sending value and the data pilot frequency sending value from the transmitting end 2, obtain TS phase estimation and compensate the TS phase estimation.

Where the receiving end is configured to estimate TS phase rotation by conjugating and multiplying TS adjacent symbols to obtain a product of sum square and phase rotation, and compensate the TS phase rotation.

The receiving end is further configured to obtain channel estimation of a TS pilot frequency point by removing an orthogonal matrix on a TS non pilot frequency position and performing the channel estimation, and performing interpolation.

The receiving end is further configured to perform phase offset compensation by estimating phase offset according to the channel estimation and current pilot frequency and updating the phase offset.

According to the apparatus for generating the pilot frequency sequence provided by the present embodiments, a pilot frequency of a data part is multiplied by an orthogonal code, so that pilot frequencies between streams are kept orthogonal, and the accuracy of phase tracking obtained at the receiving end is effectively improved, and thus, high-order modulation can be effectively dealt with.

FIG. 5 is a schematic structural diagram of an electronic device provided according to another embodiment of the present disclosure. The electronic device comprises a memory, a processor and a computer program stored on the memory and executable on the processor, the processor, when executing the program, implementing the method for generating the pilot frequency sequence in the above embodiments. The electronic device 30 shown in FIG. 5 is only an example, and should not bring any limitation to the functions and the use scope of the embodiment of the present disclosure.

As shown in FIG. 5, the electronic device 30 may be present in a form of a general purpose computing device, which may be, for example, a server device. Components of the electronic device 30 may include, but are not limited to: at least one processor 31, at least one memory 32, and a bus 33 connecting various system components (including the memory 32 and the processor 31).

The bus 33 includes a data bus, an address bus, and a control bus.

The memory 32 may include a volatile memory, such as a random access memory (RAM) 321 and/or a cache memory 322, and may further include a read-only memory (ROM) 323.

The memory 32 may also include a program/utility 325 having a set (at least one) of program modules 324, such program modules 324 including, but not limited to: an operation system, one or more application programs, other program modules and program data, each of which or some combinations thereof may include an implementation of a network environment.

The processor 31 executes various functional applications and performs data processing, such as the method for generating the pilot frequency sequence in the above embodiments of the present disclosure, by executing the computer program stored in the memory 32.

The electronic device 30 may also communicate with one or more external devices 34 (such as a keyboard and a pointing device). Such communication may be implemented through an input/output (I/O) interface 35. In addition, a model-generating device 30 may also communicate with one or more networks (such as a local area network (LAN), a wide area network (WAN), and/or a public network, such as the Internet) via a network adapter 36. As shown in FIG. 5, the network adapter 36 communicates with other modules of the model-generating device 30 via the bus 33. It should be understood that although not shown in the figures, other hardware and/or software modules may be used in conjunction with the model-generating device 30, including, but not limited to: microcode, device drivers, redundant processors, external disk drive arrays, RAID (disk array) systems, tape drives, data backup storage systems, and the like.

It should be noted that although several units/modules or sub-units/modules of the electronic device are mentioned in the above detailed description, such a division is merely exemplary but not mandatory. Indeed, the features and functions of two or more of the units/modules described above may be embodied in one unit/module according to embodiments of the present disclosure. Conversely, the features and functions of one unit/module described above may be further divided to be embodied by a plurality of units/modules.

The present embodiments further provide a computer-readable storage medium having a computer program stored thereon, the program, when executed by a processor, implementing steps of the method for generating the pilot frequency sequence in the above embodiments.

Where the readable storage medium may be employed more specifically and may include, but is not limited to: a portable disk, a hard disk, a random access memory, a read-only memory, an erasable programmable read-only memory, an optical storage device, a magnetic storage device, or any suitable combination of the foregoing.

In a possible embodiment, the present disclosure may also be implemented in a form of a program product comprising a program code used for causing a terminal device to implement steps of the method for generating the pilot frequency sequence in the above embodiments when the program product is executed on the terminal device.

Where the program code used for implementing the present disclosure are written in any combination of one or more programming languages, where the program code may be executed entirely on a user device, partly on the user device, as a stand-alone software package, partly on the user device and partly on a remote device, or entirely on the remote device.

Although specific embodiments of the present disclosure have been described above, it should be understood by those skilled in the art that these embodiments are merely illustrative and that the protection scope of the present disclosure is defined by the appended claims. Various changes or modifications may be made to these embodiments by those skilled in the art without departing from the principle and spirit of the present disclosure, and such changes and modifications shall fall within the protection scope of the present disclosure.

1. A method for generating a pilot frequency sequence, comprising:
generating a data pilot frequency by a data pilot frequency generator of a transmitting end, and generating a multi-stream data pilot frequency sequence by a multi-stream data pilot frequency sequence mapper of the transmitting end;
generating an orthogonal code by an orthogonal code generator of the transmitting end, and generating an extracted orthogonal code word by a column loop extractor of the transmitting end;
obtaining, by the transmitting end, a data pilot frequency sending value by multiplying the multi-stream data pilot frequency sequence of each symbol by the corresponding orthogonal code word; and
sending, by the transmitting end, the data pilot frequency sending value to a receiving end.

2. The method for generating the pilot frequency sequence according to claim 1, wherein, the method further comprises:
obtaining a TS pilot frequency sending value by generating a pilot frequency TS pilot frequency by a TS pilot frequency generator of the transmitting end and generating a multi-stream TS pilot frequency sequence by a multi-stream TS pilot frequency sequence mapper of the transmitting end; and
sending the TS pilot frequency sending value to the receiving end.

3. The method for generating the pilot frequency sequence according to claim 2, wherein, the method further comprises:
generating a multi-stream TS OFDM symbol and a multi-stream data OFDM symbol by an OFDM symbol generator of the transmitting end, inserting the multi-stream TS pilot frequency sequence between the multi-stream TS OFDM symbols, and inserting the multi-stream data pilot frequency sequence between the multi-stream data OFDM symbols.

4. The method for generating the pilot frequency sequence according to claim 2, wherein, the TS pilot frequency sending value and the data pilot frequency sending value are configured to enable the receiving end to:
obtain TS phase estimation;
compensate the TS phase estimation;
obtain channel estimation of a TS pilot frequency point by removing an orthogonal matrix on a TS non pilot frequency position and performing channel estimation, and performing interpolation; and
perform phase offset compensation by estimating a phase offset according to the channel estimation and current pilot frequency and updating the phase offset.

5. The method for generating the pilot frequency sequence according to claim 4, wherein, the TS pilot frequency sending value and the data pilot frequency sending value are configured to enable the receiving end to obtain the TS phase estimation and compensate the TS phase estimation comprising:
the TS pilot frequency sending value and the data pilot frequency sending value are configured to enable the receiving end to estimate TS phase rotation by conjugating and multiplying TS adjacent symbols to obtain a product of sum square and phase rotation; and
compensate the TS phase rotation.

6. The method for generating the pilot frequency sequence according to claim 1, wherein, the method for generating the pilot frequency sequence is applied to a Wi-Fi communication system.

7-12. (canceled)

13. An electronic device, comprising a memory, a processor and a computer program stored on the memory and executable on the processor, wherein, the processor is configured to:
generate a data pilot frequency by a data pilot frequency generator, and generate a multi-stream data pilot frequency sequence by a multi-stream data pilot frequency sequence mapper;
generate an orthogonal code by an orthogonal code generator, and generate an extracted orthogonal code word by a column loop extractor;
obtain a data pilot frequency sending value by multiplying the multi-stream data pilot frequency sequence of each symbol by the corresponding orthogonal code word; and
send the data pilot frequency sending value to a receiving end.

14. A computer-readable medium having a computer instruction stored thereon, wherein, the computer instruction, when executed by a processor, implements:
generating a data pilot frequency by a data pilot frequency generator, and generating a multi-stream data pilot frequency sequence by a multi-stream data pilot frequency sequence mapper;
generating an orthogonal code by an orthogonal code generator, and generating an extracted orthogonal code word by a column loop extractor;
obtaining a data pilot frequency sending value by multiplying the multi-stream data pilot frequency sequence of each symbol by the corresponding orthogonal code word; and
sending the data pilot frequency sending value to a receiving end.

15. The electronic device according to claim 13, wherein, the processor is further configured to:
obtain a TS pilot frequency sending value by generating a TS pilot frequency by a TS pilot frequency generator and generating a multi-stream TS pilot frequency sequence by a multi-stream TS pilot frequency sequence mapper; and
send the TS pilot frequency sending value to the receiving end.

16. The electronic device according to claim 15, wherein, the processor is further configured to:
generate a multi-stream TS OFDM symbol and a multi-stream data OFDM symbol by an OFDM symbol generator, insert the multi-stream TS pilot frequency sequence between the multi-stream TS OFDM symbols, and insert the multi-stream data pilot frequency sequence between the multi-stream data OFDM symbols.

17. The electronic device according to claim 15, wherein, the TS pilot frequency sending value and the data pilot frequency sending value are configured to enable the receiving end to:
obtain TS phase estimation;
compensate the TS phase estimation;
obtain channel estimation of a TS pilot frequency point by removing an orthogonal matrix on a TS non pilot frequency position and performing channel estimation, and performing interpolation; and
perform phase offset compensation by estimating a phase offset according to the channel estimation and current pilot frequency and updating the phase offset.

18. The electronic device according to claim 17, wherein, the TS pilot frequency sending value and the data pilot frequency sending value are configured to enable the receiving end to obtain the TS phase estimation and compensate the TS phase estimation comprising:
the TS pilot frequency sending value and the data pilot frequency sending value are configured to enable the receiving end to estimate TS phase rotation by conjugating and multiplying TS adjacent symbols to obtain a product of sum square and phase rotation; and compensate the TS phase rotation.

19. The electronic device according to claim 15, wherein, the electronic device is applied to a Wi-Fi communication system.

20. The computer-readable medium according to claim 14, wherein, the computer instruction, when executed by a processor, further implements:
obtaining a TS pilot frequency sending value by generating a TS pilot frequency by a TS pilot frequency generator and generating a multi-stream TS pilot frequency sequence by a multi-stream TS pilot frequency sequence mapper; and
sending the TS pilot frequency sending value to the receiving end.

21. The computer-readable medium according to claim 20, wherein, the computer instruction, when executed by a processor, further implements:
generating a multi-stream TS OFDM symbol and a multi-stream data OFDM symbol by an OFDM symbol generator, inserting the multi-stream TS pilot frequency sequence between the multi-stream TS OFDM symbols, and inserting the multi-stream data pilot frequency sequence between the multi-stream data OFDM symbols.

22. The computer-readable medium according to claim 20, wherein, the TS pilot frequency sending value and the data pilot frequency sending value are configured to enable the receiving end to:
obtain TS phase estimation;
compensate the TS phase estimation;
obtain channel estimation of a TS pilot frequency point by removing an orthogonal matrix on a TS non pilot frequency position and performing channel estimation, and performing interpolation; and
perform phase offset compensation by estimating a phase offset according to the channel estimation and current pilot frequency and updating the phase offset.

23. The computer-readable medium according to claim 22, wherein, the TS pilot frequency sending value and the data pilot frequency sending value are configured to enable the receiving end to obtain the TS phase estimation and compensate the TS phase estimation comprising:
the TS pilot frequency sending value and the data pilot frequency sending value are configured to enable the receiving end to estimate TS phase rotation by conjugating and multiplying TS adjacent symbols to obtain a product of sum square and phase rotation; and compensate the TS phase rotation.

24. The computer-readable medium according to claim 14, wherein, the computer-readable medium is applied to a Wi-Fi communication system
